(19) United States
(12) Patent Application Publication
(10) Pub. No.: US 2022/0303208 A1
(43) Pub. Date: Sep. 22, 2022

(54) METHOD FOR ARTIFICIAL INTELLIGENT SOFTWARE DEFINED NETWORK ENABLED BORDER GATEWAY PROTOCOL ROUTING DISASTER RECOVERY

(71) Applicant: AT&T Intellectual Property I, L.P., Atlanta, GA (US)

(72) Inventors: Moshiur Rahman, Marlboro, NJ (US); Steven Solomon, Freehold, NJ (US)

(21) Appl. No.: 17/204,653

(22) Filed: Mar. 17, 2021

(51) Int. Cl. H04L 12/751; H04L 12/707; H04L 29/06; G06N 5/04; H04L 12/24

(52) U.S. Cl. CPC H04L 45/02; H04L 45/22; H04L 63/1458; G06N 5/04; H04L 41/16; H04L 41/12; G06N 20/00

(57) ABSTRACT

A method includes receiving, by a software defined network (SDN) node, first telemetry data for components of a native autonomous system (AS) network. The method further includes analyzing, by the artificial intelligence module, the first telemetry data in order to predetermine network paths to route traffic during a network capacity shortage and based on the analyzing of the first telemetry data, generating routing data of predetermined network paths to route traffic. The method further includes sending the routing data within the native AS and between the native AS and the neighboring AS. The method further includes receiving, from the neighboring AS, neighboring data and in response to receiving the neighboring data, analyzing, by the artificial intelligence module, the neighboring data, and based on the analyzing of the neighboring data and the first telemetry data for components of the native AS network, updating the routing data.

### TECHNICAL FIELD

This disclosure is directed to a system and method for managing software-defined networks, and, more specifically, to disaster recovery for routers by utilizing alternate paths through alternate non-traditional networks.

### BACKGROUND

Communication networks have migrated from using specialized networking equipment executing on dedicated hardware, like routers, firewalls, and gateways, to software defined networks (SDNs) executing as virtualized network functions (VNF) in a cloud infrastructure. To provide a service, a set of VNFs may be instantiated on general-purpose hardware. Each VNF may require one or more virtual machines (VMs) to be instantiated. In turn, VMs may require various resources, such as memory, virtual central processing units (vCPUs), and network interfaces or network interface cards (NICs).

DDoS (Distributed Denial of Service) mitigation service provides critical protection for businesses, institutions, and other organizations against DDoS attacks that have become ever more frequent, widespread, and larger in volume. Common DDoS mitigation services divert attack traffic, by changing routers' routing table entries, from its intended destination (customer) addresses to addresses associated with scrubber facility, where the attack traffic is removed and the clean traffic is then returned to the customer.

This background information is provided to reveal information believed by the applicant to be of possible relevance. No admission is necessarily intended, nor should be construed, that any of the preceding information constitutes prior art.

### SUMMARY

Disclosed herein is a device having a processor and a memory coupled with the processor. The processor effectuates operations including receiving, by a software defined network (SDN) node, first telemetry data for components of a native autonomous system (AS) network, wherein the components of the native AS network comprise edge network devices and core network devices, wherein the SDN node comprises an artificial intelligence module. The processor further effectuates operations including analyzing, by the artificial intelligence module, the first telemetry data in order to predetermine network paths to route traffic during a network capacity shortage. The processor further effectuates operations including based on the analyzing of the first telemetry data, generating routing data of predetermined network paths to route traffic within the native AS and between the native AS and a neighboring AS during the network capacity shortage. The processor further effectuates operations including sending the routing data of predetermined network paths to route traffic within the native AS and between the native AS and the neighboring AS. The processor further effectuates operations including receiving, from the neighboring AS, neighboring data. The processor further effectuates operations including in response to receiving the neighboring data, analyzing, by the artificial intelligence module, the neighboring data. The processor further effectuates operations including based on the analyzing of the neighboring data and the first telemetry data for components of the native AS network, updating the routing data.

Disclosed herein is a computer-implemented method. The computer-implemented method includes receiving, by a software defined network (SDN) node, first telemetry data for components of a native autonomous system (AS) network, wherein the components of the native AS network comprise edge network devices and core network devices, wherein the SDN node comprises an artificial intelligence module. The computer-implemented method further includes analyzing, by the artificial intelligence module, the first telemetry data in order to predetermine network paths to route traffic during a network capacity shortage. The computer-implemented method further includes based on the analyzing of the first telemetry data, generating routing data of predetermined network paths to route traffic within the native AS and between the native AS and a neighboring AS during the network capacity shortage. The computer-implemented method further includes sending the routing data of predetermined network paths to route traffic within the native AS and between the native AS and the neighboring AS. The computer-implemented method further includes receiving, from the neighboring AS, neighboring data. The computer-implemented method further includes in response to receiving the neighboring data, analyzing, by the artificial intelligence module, the neighboring data. The computer-implemented method further includes based on the analyzing of the neighboring data and the first telemetry data for components of the native AS network, updating the routing data.

Disclosed herein is a computer-readable storage medium storing executable instructions that when executed by a computing device cause said computing device to effectuate operations including receiving, by a software defined network (SDN) node, first telemetry data for components of a native autonomous system (AS) network, wherein the components of the native AS network comprise edge network devices and core network devices, wherein the SDN node comprises an artificial intelligence module. Operations further include analyzing, by the artificial intelligence module, the first telemetry data in order to predetermine network paths to route traffic during a network capacity shortage. Operations further include based on the analyzing of the first telemetry data, generating routing data of predetermined network paths to route traffic within the native AS and between the native AS and a neighboring AS during the network capacity shortage. Operations further include sending the routing data of predetermined network paths to route traffic within the native AS and between the native AS and the neighboring AS. Operations further include receiving, from the neighboring AS, neighboring data. Operations further include in response to receiving the neighboring data, analyzing, by the artificial intelligence module, the neighboring data. Operations further include based on the analyzing of the neighboring data and the first telemetry data for components of the native AS network, updating the routing data.

### BRIEF DESCRIPTION OF THE DRAWINGS

Aspects of the herein described telecommunications network and systems and methods are described more fully with reference to the accompanying drawings, which provide examples. In the following description, for purposes of explanation, numerous specific details are set forth in order to provide an understanding of the variations in implementing the disclosed technology. However, the instant disclosure may take many different forms and should not be construed as limited to the examples set forth herein. Where practical, like numbers refer to like elements throughout.

FIG. 1A is a representation of an exemplary network in accordance with the present disclosure;

FIG. 1B is a representation of an exemplary hardware platform for a network in accordance with the present disclosure;

FIG. 2 is a schematic of an exemplary system architecture in accordance with the present disclosure;

FIG. 3 is a flowchart of an exemplary method of operation for the architecture described in FIG. 2;

FIG. 4 is a schematic of an exemplary network device;

FIG. 5 depicts an exemplary communication system that provide wireless telecommunication services over wireless communication networks with which edge computing node may communicate;

FIG. 6 depicts an exemplary communication system that provide wireless telecommunication services over wireless communication networks with which edge computing node may communicate; and

FIG. 7 is a diagram of an exemplary telecommunications system in which the disclosed methods and processes may be implemented with which edge computing node may communicate.

### DETAILED DESCRIPTION

Routing Control Platforms (RCP) pioneered refactoring IP routing architectures to create a logically centralized control plane separated from forwarding elements. RCPs allow an individual AS to deploy new, customer-facing services and also provide a good perspective on network effectiveness but cannot guarantee an availability and QoS (SLA) of BGP routings. Current BGP implementations tend to be limited to respective ISPs internal routing resources and may not be able to leverage out of domain routing resources to connect (intra-/inter-) routers, including BGP routers, within and beyond respective ASes.

Moreover, BGPs exchange routing information between autonomous systems (AS). Routers use the routing information to locally decide, among a set of neighboring routers, which router to send IP (and other) traffic based on the target network prefix. An SDN may be used to decouple data-plane forwarding from control and management plane functions. OpenFlow as a protocol (or API) may be used to separate controller and forwarding elements. Typical SDN architectures are not capable of choosing alternate paths out of alternate networks and cannot be shared among multiple autonomous systems (ASes)/Internet service providers (ISPs) for intra- or inter-AS disaster recovery.

In addition, increased use of demanding network applications, as well as the increase of unwanted network traffic in the form of DDoS attacks, are putting new pressure on service providers to meet the expectations of customers in terms of network availability and performance. Service providers are expected to deal with potential problems in near real-time. Further, many of these demanding applications, such as VoIP and online gaming, and dynamic connectivity for first responders' apps, are very sensitive to even small periods of disruption.

Accordingly, providing a centralized intelligent route service control point in an SDN, which may allow route selection to be performed outside the SIP's BGP routers may be beneficial. Disaster recovery for routers may be achieved by implemented using dynamic connectivity management using machine learning (ML) to dynamically manage how and where traffic flows fail across a network. Disaster recovery may further be aided by utilizing dynamic available alternate paths over alternate network domains, including satellite and powerline.

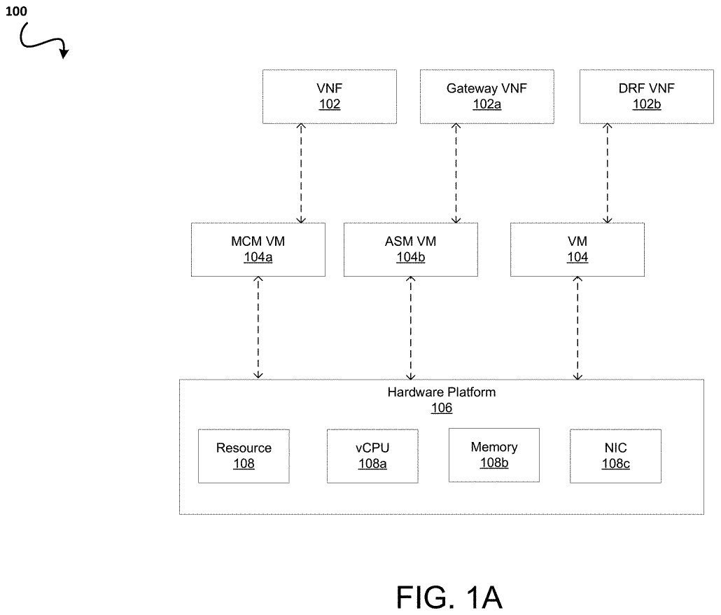

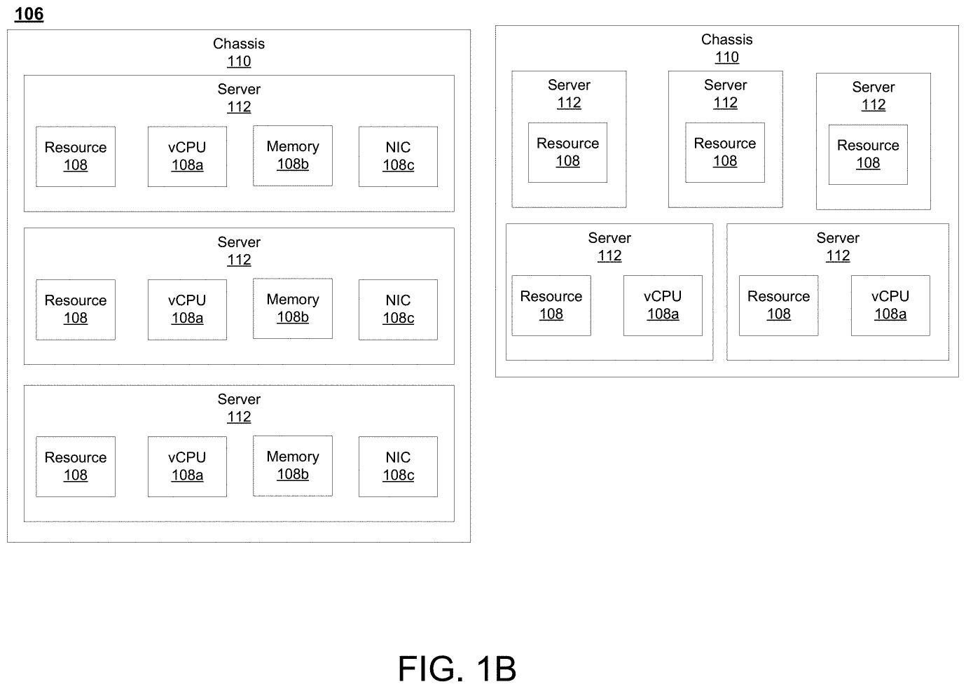

FIG. 1A is a representation of an exemplary network 100. Network 100 may comprise a software defined network (SDN). For example, network 100 may include one or more virtualized functions implemented on general purpose hardware, such as in lieu of having dedicated hardware for every network function. General purpose hardware of network 100 may be configured to run virtual network elements to support communication services, such as mobility services, including consumer services and enterprise services. These services may be provided or measured in sessions.

A virtual network function(s) (VNF) 102 may be able to support a limited number of sessions. Each VNF 102 may have a VNF type that indicates its functionality or role. For example, FIG. 1A illustrates a gateway VNF 102a and a disaster recovery function (DRF) VNF 102b. Additionally or alternatively, VNFs 102 may include other types of VNFs including but not limited to security, routing, wide area network (WAN) optimization and others within a service providers virtual network offerings. According to the example, VNF 102b may provide disaster recovery for BGP routers by leveraging alternate paths through alternate non-traditional networks, such as satellite or powerline as described more completely below.

Each VNF 102 may use one or more virtual machine (VM) 104 to operate. Each VM 104 may have a VM type that indicates its functionality or role. For example, FIG. 1A illustrates a management control module (MCM) VM 104a and an advanced services module (ASM) VM 104b. VM 104 may include other types of VMs. Each VM 104 may consume various network resources from a hardware platform 106, such as a resource 108, a virtual central processing unit (vCPU) 108a, memory 108b, or a network interface card (MC) 108c. Additionally or alternatively, hardware platform 106 may include other types of resources 108.

While FIG. 1A illustrates resources 108 as collectively contained in hardware platform 106, the configuration of hardware platform 106 may isolate, for example, certain memory 108c from other memory 108a. FIG. 1B provides an exemplary implementation of hardware platform 106.

Hardware platform 106 may comprise one or more chasses 110. Chassis 110 may refer to the physical housing or platform for multiple servers or other network equipment. In an aspect, chassis 110 may also refer to the underlying network equipment. Chassis 110 may include one or more servers 112. Server 112 may comprise general purpose computer hardware or a computer. In an aspect, chassis 110 may comprise a metal rack, and servers 112 of chassis 110 may comprise blade servers that are physically mounted in or on chassis 110.

Each server 112 may include one or more network resources 108, as illustrated. Servers 112 may be communicatively coupled together in any combination or arrangement. For example, all servers 112 within a given chassis 110 may be communicatively coupled. As another example, servers 112 in different chasses 110 may be communicatively coupled. Chasses 110 may be communicatively coupled together in any combination or arrangement.

The characteristics of each chassis 110 and each server 112 may differ. For example, FIG. 1B illustrates that the number of servers 112 within two chasses 110 may vary. The type or number of resources 110 within each server 112 may vary. In an aspect, chassis 110 may be used to group servers 112 with the same resource characteristics. In another aspect, servers 112 within the same chassis 110 may have different resource characteristics.

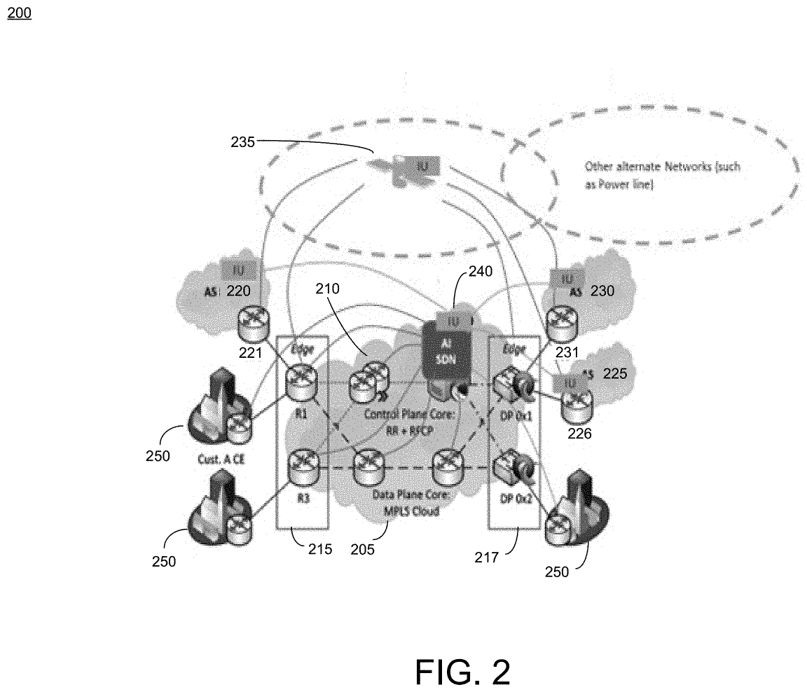

FIG. 2 illustrates an exemplary system architecture 200 including according to one or more embodiments. The system architecture 200 may provide an AI enabled SDN based disaster recovery for BGP routers by leveraging alternate paths through alternate non-traditional networks (e.g., satellite or powerline). The system architecture 200 may include an SDN component, an AI component of the SDN component, and an Intelligent unit (IU) and may be divided into a data plane portion 205, a control plane portion 210, and one or more edges (e.g., edge 215 and edge 217). Each edge may include routers or data paths (e.g., R1, R3, data path 0x1, data path 0x2, etc.) that peer with external autonomous systems and may be configured to provide services to customer edge (CE) devices (e.g., CE 250).

The SDN component of the system architecture 200 may be an autonomous system (AS) (e.g., AI SDN 240) that connects to external networks with one or more autonomous systems (ASes) (e.g., AS 220, AS 225, or AS 230), which interfaces with the SDN component through respective routers associated with each of the external networks (e.g., BGP routers 221, 226, and 231). The IU may be a network control element assigned to each of the ASes, the AS and satellite 235. The IU of the AI SDN 240 may operate in the control plane portion 210 but may not operate in a data path. For example, the IU may communicate with routers via, for example, an Internal Border Gateway Protocol (iBGP). The iBGP may receive routes from the routers and perform route selection on behalf of each of the routers. The iBGP may also communicate the selected routes back to each of the routers.

The IU of the AI SDN 240 also uses an interior gateway protocol (IGP), like Open Shortest Path First (OSPF), to perform per-router route selection and tiebreaks during the BGP route selection process. When the IU of the AI SDN 240 is a part of the iBGP process, the IU may not control all route selections in the network 100. When the IU of the AI SDN 240 does not control route selection, the routers may make their own route selection decisions based on routes learned via an External Border Gateway Protocol (EBGP), which may be used for communication between distinct ASes.

Forms of input utilized by the IU AI SDN 240 may be, for example, direct operator input and network intelligence. Direct operator input may entail performing a task, for example, blackholing DDoS traffic by discarding incoming or outgoing network traffic without informing a source that the data did not reach the intended recipient. Network intelligence may entail data representing, for example, the fact that the IU may allow external information to directly impact a routing process. For example, during a VPN gateway selection, the network intelligence may be a customer preference. In another example, for both a VPN gateway selection and a network aware load-balancing, the network intelligence may be based on network monitoring. Accordingly, the routing process may be handled in dynamic fashion using external information, while the AI enabled SDN may handle exchange to exchange (E2E) network intelligence processing.

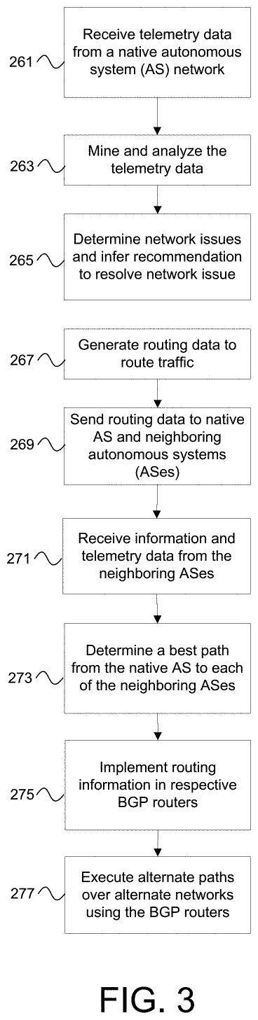

An exemplary operational flowchart in accordance with a method of the present disclosure is illustrated in FIG. 3, which may be utilized for disaster recovery. At block 261, an IU of the AI SDN 240 may receive telemetry data (e.g., capacity availability, call drops, routing links, network or device failure data, specific network metrics, time synchronization, local device traffic statistics, system status information, Syslog, Simple Network Management Protocol (SNMP), access control list (ACL) Logging, accounting, archive configuration change logger, packet capture, interface type, status, speed and duplex, encapsulation, errors on the interface, the last time a network device interface bounced, last time the network device or interface error counters reset, utilization of the network device components (e.g., CPU, interface bandwidth), IP addresses configured on a network device, subnet mask, and media access control (MAC) address configured on the network device, Global Positioning System (GPS) location of a network device, or facility location of a network device, among other things) from a native AS within network 100. For example, system architecture 200 may include edge network devices and core network devices. At block 263, the IU of the AI SDN 240 may analyze the telemetry data, for example, in real time or batch mode. For example, the IU of the AI SDN 240 may compare the telemetry data to historical network data, including previous network recoveries.

At block 265, the IU of the AI SDN 240, using the analyzed telemetry data, may determine network issues (e.g., network capacity shortages in which a maximum amount of data transferred between network locations over a link or network path exceeds a predetermined threshold, bandwidth exhaustion in which a large volume of traffic is used to overwhelm the bandwidth of a target network, any failures (e.g., data plane failures) within the native AS, etc.), which may cause routing paths for intra-ISP AS or inter-ISPs ASes to be dropped from a routing table or exceed capacity. At block 267, using the mined data and determined network issues, the IU of the AI SDN 240 may generate routing data (e.g., a table of predetermined network paths) to route traffic within the native AS and between the native AS and neighboring ASes in response to the determined network issues. At block 269, the IU of the AI SDN 240 may send the routing data to the native AS and neighboring ASes. At block 271, the IU of the AI SDN 240 may receive telemetry data (e.g., capacity availability, call drops, routing links, or device failure data) from neighboring ASes to the AS.

At block 273, the IU of the AI SDN 240 may determine a best path for each destination prefix at each router (e.g., a route for each destination prefix selected from all heard routes based on the routing policies and BGP advertisements) from the native AS to the neighboring ASes by, for example, selecting a routing path from a combined list of the intra-ASes/inter-ASes and domain routes. At block 275, the IU of the AI SDN 240 may provide routing updates by delivering routing information to respective routers (e.g., BGP routers) within the network 100 using a given protocol (e.g., OpenFlow) in order to ensure availability and SLA (performance) by leveraging alternate paths through alternate networks, such as satellite or powerline. For example, alternates paths may be needed to address a network issue necessitating disaster recovery (e.g., BGP disaster recovery). At block 277, the routers, using the updated routing information, may begin to utilize the new alternate path over the alternate networks.

Accordingly, the present disclosure provides a system that determines and provides path calculation on a per client or group of clients' basis using ML that operate off diverse data set collected from inter-AS and intra-AS routing data, including DV (Distance Vector route change notification and failure) data. Under the lens of AI SDN, this solution provides dynamic connectivity management and a central routing path selection mechanism from a combined list of the traditional intra-ASes/inter-ASes and out of domain routes. The routes from out of domain (networks), such as satellite-based or powerline based, are sharable among participating ISPs (ASes).

The system described herein may utilize an Intelligent Unit (IU) network control element, which communicates with routers via iBGP. The IU receives routes from routers, performs route selection on behalf of each router and communicating the selected routes back to the routers. The IU also makes use of an interior gateway protocol (IGP), like OSPF, to perform per-router route selection and to break ties as part of the normal BGP route selection process. The IU may utilize multiple forms of input. The input may be a direct operator input, for example when a task like blackholing of DDoS traffic is performed, or a network intelligence input that allows external information to directly impact the routing process.

The system described herein may implement a messaging flow in a disaster recovery in response to a network issue in which:
All network components from edge devices and core devices of a native AS (ISP) network sends telemetry data, including capacity availability, call drops, routing links' flip flops and network or device failures data to the AI SDN.
AI SDN mines the data both in real time and batch mode and determines network capacity shortages, links' exhaustion and/or any failures within the AS and infers actionable recommendations, such as hunting and switching over an alternate path (e.g., rules and policies of checking for any other alternate path and instructing the network (routers) to take the alternate path).
IU interfaces with the neighboring ASes, receives this actionable information from AI SDN and performs further processing using all other telemetries received from the neighboring ASes and decides the best path from the originating AS to the destination ASes.
AI SDN based on the information received from IU implements the routing information in the respective BGP routers by using any specific protocol, e.g., OpenFlow.
After having the routing information updated, the BGP router starts using/executing the new alternate path over the alternate network, such as satellite network.

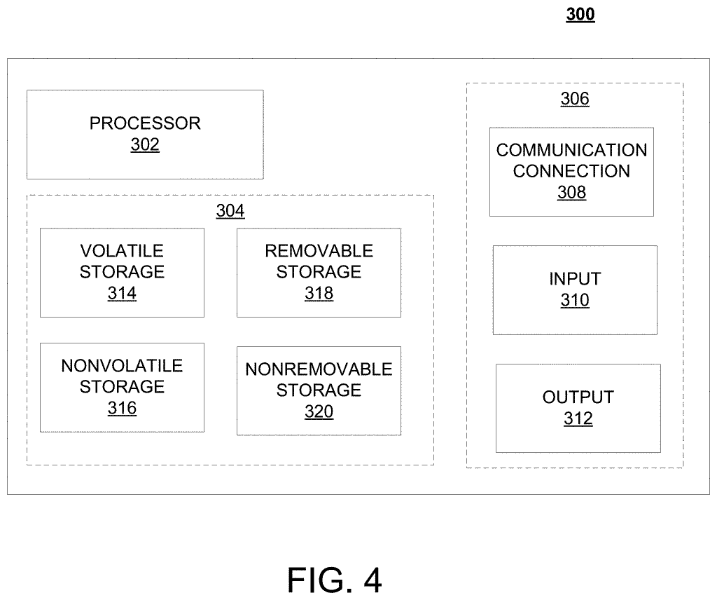

FIG. 4 is a block diagram of network device 300 that may be associated with equipment of FIG. 1A through FIG. 3. Network device 300 may comprise hardware or a combination of hardware and software. The functionality to facilitate telecommunications via a telecommunications network may reside in one or combination of network devices 300. Network device 300 depicted in FIG. 4 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an ALFS, a gateway mobile location center (GMLC), a radio access network (RAN), a serving mobile location center (SMLC), or the like, or any appropriate combination thereof. It is emphasized that the block diagram depicted in FIG. 4 is exemplary and not intended to imply a limitation to a specific implementation or configuration. Thus, network device 300 may be implemented in a single device or multiple devices (e.g., single server or multiple servers, single gateway or multiple gateways, single controller, or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 4) to allow communications therebetween. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a nonremovable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

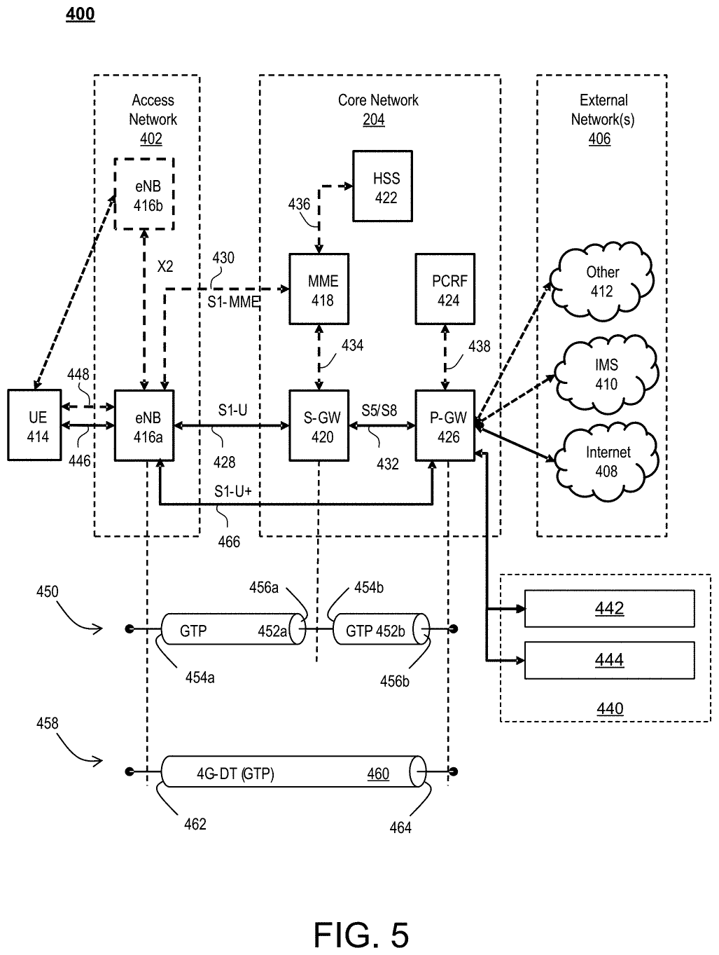

FIG. 5 illustrates a functional block diagram depicting one example of an LTE-EPS network architecture 400 related to the current disclosure. In particular, the network architecture 400 disclosed herein is referred to as a modified LTE-EPS architecture 400 to distinguish it from a traditional LTE-EPS architecture.

An example modified LTE-EPS architecture 400 is based at least in part on standards developed by the 3rd Generation Partnership Project (3GPP), with information available at www.3gpp.org. In one embodiment, the LTE-EPS network architecture 400 includes an access network 402, a core network 404, e.g., an EPC or Common BackBone (CBB) and one or more external networks 406, sometimes referred to as PDN or peer entities. Different external networks 406 can be distinguished from each other by a respective network identifier, e.g., a label according to DNS naming conventions describing an access point to the PDN. Such labels can be referred to as Access Point Names (APN). External networks 406 can include one or more trusted and non-trusted external networks such as an internet protocol (IP) network 408, an IP multimedia subsystem (IMS) network 410, and other networks 412, such as a service network, a corporate network, or the like.

Access network 402 can include an LTE network architecture sometimes referred to as Evolved Universal mobile Telecommunication system Terrestrial Radio Access (E UTRA) and evolved UMTS Terrestrial Radio Access Network (E-UTRAN). Broadly, access network 402 can include one or more communication devices, commonly referred to as UE 414, and one or more wireless access nodes, or base stations 416a, 416b. During network operations, at least one base station 416 communicates directly with UE 414. Base station 416 can be an evolved Node B (eNodeB), with which UE 414 communicates over the air and wirelessly. UEs 414 can include, without limitation, wireless devices, e.g., satellite communication systems, portable digital assistants (PDAs), laptop computers, tablet devices, Internet-of-things (IoT) devices, and other mobile devices (e.g., cellular telephones, smart appliances, and so on). UEs 414 can connect to eNBs 416 when UE 414 is within range according to a corresponding wireless communication technology.

UE 414 generally runs one or more applications that engage in a transfer of packets between UE 414 and one or more external networks 406. Such packet transfers can include one of downlink packet transfers from external network 406 to UE 414, uplink packet transfers from UE 414 to external network 406 or combinations of uplink and downlink packet transfers. Applications can include, without limitation, web browsing, VoIP, streaming media, and the like. Each application can pose different Quality of Service (QoS) requirements on a respective packet transfer. Different packet transfers can be served by different bearers within core network 404, e.g., according to parameters, such as the QoS.

Core network 404 uses a concept of bearers, e.g., EPS bearers, to route packets, e.g., IP traffic, between a particular gateway in core network 404 and UE 414. A bearer refers generally to an IP packet flow with a defined QoS between the particular gateway and UE 414. Access network 402, e.g., E UTRAN, and core network 404 together set up and release bearers as required by the various applications. Bearers can be classified in at least two different categories: (i) minimum guaranteed bit rate bearers, e.g., for applications, such as VoIP; and (ii) non-guaranteed bit rate bearers that do not require guarantee bit rate, e.g., for applications, such as web browsing.

In one embodiment, the core network 404 includes various network entities, such as MME 418, SGW 420, Home Subscriber Server (HSS) 422, Policy and Charging Rules Function (PCRF) 424 and PGW 426. In one embodiment, MME 418 comprises a control node performing a control signaling between various equipment and devices in access network 402 and core network 404. The protocols running between UE 414 and core network 404 are generally known as Non-Access Stratum (NAS) protocols.

For illustration purposes only, the terms MME 418, SGW 420, HSS 422 and PGW 426, and so on, can be server devices, but may be referred to in the subject disclosure without the word “server.” It is also understood that any form of such servers can operate in a device, system, component, or other form of centralized or distributed hardware and software. It is further noted that these terms and other terms such as bearer paths or interfaces are terms that can include features, methodologies, or fields that may be described in whole or in part by standards bodies such as the 3GPP. It is further noted that some or all embodiments of the subject disclosure may in whole or in part modify, supplement, or otherwise supersede final or proposed standards published and promulgated by 3GPP.

According to traditional implementations of LTE-EPS architectures, SGW 420 routes and forwards all user data packets. SGW 420 also acts as a mobility anchor for user plane operation during handovers between base stations, e.g., during a handover from first eNB 416a to second eNB 416b as may be the result of UE 414 moving from one area of coverage, e.g., cell, to another. SGW 420 can also terminate a downlink data path, e.g., from external network 406 to UE 414 in an idle state and trigger a paging operation when downlink data arrives for UE 414. SGW 420 can also be configured to manage and store a context for UE 414, e.g., including one or more of parameters of the IP bearer service and network internal routing information. In addition, SGW 420 can perform administrative functions, e.g., in a visited network, such as collecting information for charging (e.g., the volume of data sent to or received from the user), or replicate user traffic, e.g., to support a lawful interception. SGW 420 also serves as the mobility anchor for interworking with other 3GPP technologies such as universal mobile telecommunication system (UMTS).

At any given time, UE 414 is generally in one of three different states: detached, idle, or active. The detached state is typically a transitory state in which UE 414 is powered on but is engaged in a process of searching and registering with network 402. In the active state, UE 414 is registered with access network 402 and has established a wireless connection, e.g., radio resource control (RRC) connection, with eNB 416. Whether UE 414 is in an active state can depend on the state of a packet data session, and whether there is an active packet data session. In the idle state, UE 414 is generally in a power conservation state in which UE 414 typically does not communicate packets. When UE 414 is idle, SGW 420 can terminate a downlink data path, e.g., from one peer entity 406, and triggers paging of UE 414 when data arrives for UE 414. If UE 414 responds to the page, SGW 420 can forward the IP packet to eNB 416a.

HSS 422 can manage subscription-related information for a user of UE 414. For example, HSS 422 can store information such as authorization of the user, security requirements for the user, quality of service (QoS) requirements for the user, etc. HSS 422 can also hold information about external networks 406 to which the user can connect, e.g., in the form of an APN of external networks 406. For example, MME 418 can communicate with HSS 422 to determine if UE 414 is authorized to establish a call, e.g., a voice over IP (VoIP) call before the call is established.

PCRF 424 can perform QoS management functions and policy control. PCRF 424 is responsible for policy control decision-making, as well as for controlling the flow-based charging functionalities in a policy control enforcement function (PCEF), which resides in PGW 426. PCRF 424 provides the QoS authorization, e.g., QoS class identifier and bit rates that decide how a certain data flow will be treated in the PCEF and ensures that this is in accordance with the user's subscription profile.

PGW 426 can provide connectivity between the UE 414 and one or more of the external networks 406. In illustrative network architecture 400, PGW 426 can be responsible for IP address allocation for UE 414, as well as one or more of QoS enforcement and flow-based charging, e.g., according to rules from the PCRF 424. PGW 426 is also typically responsible for filtering downlink user IP packets into the different QoS-based bearers. In at least some embodiments, such filtering can be performed based on traffic flow templates. PGW 426 can also perform QoS enforcement, e.g., for guaranteed bit rate bearers. PGW 426 also serves as a mobility anchor for interworking with non-3GPP technologies such as CDMA2000.

Within access network 402 and core network 404 there may be various bearer paths/interfaces, e.g., represented by solid lines 428 and 430. Some of the bearer paths can be referred to by a specific label. For example, solid line 428 can be considered an S1-U bearer and solid line 432 can be considered an S5/S8 bearer according to LTE-EPS architecture standards. Without limitation, reference to various interfaces, such as S1, X2, S5, S8, S11 refer to EPS interfaces. In some instances, such interface designations are combined with a suffix, e.g., a “U” or a “C” to signify whether the interface relates to a “User plane” or a “Control plane.” In addition, the core network 404 can include various signaling bearer paths/interfaces, e.g., control plane paths/interfaces represented by dashed lines 430, 434, 436, and 438. Some of the signaling bearer paths may be referred to by a specific label. For example, dashed line 430 can be considered as an S1-MME signaling bearer, dashed line 434 can be considered as an S11 signaling bearer and dashed line 436 can be considered as an S6a signaling bearer, e.g., according to LTE-EPS architecture standards. The above bearer paths and signaling bearer paths are only illustrated as examples and it should be noted that additional bearer paths and signaling bearer paths may exist that are not illustrated.

Also shown is a novel user plane path/interface, referred to as the S1-U+ interface 466. In the illustrative example, the S1-U+ user plane interface extends between the eNB 416a and PGW 426. Notably, S1-U+ path/interface does not include SGW 420, a node that is otherwise instrumental in configuring or managing packet forwarding between eNB 416a and one or more external networks 406 by way of PGW 426. As disclosed herein, the S1-U+ path/interface facilitates autonomous learning of peer transport layer addresses by one or more of the network nodes to facilitate a self-configuring of the packet forwarding path. In particular, such self-configuring can be accomplished during handovers in most scenarios so as to reduce any extra signaling load on the S/PGWs 420, 426 due to excessive handover events.

In some embodiments, PGW 426 is coupled to storage device 440, shown in phantom. Storage device 440 can be integral to one of the network nodes, such as PGW 426, for example, in the form of internal memory or disk drive. It is understood that storage device 440 can include registers suitable for storing address values. Alternatively, or in addition, storage device 440 can be separate from PGW 426, for example, as an external hard drive, a flash drive, or network storage.

Storage device 440 selectively stores one or more values relevant to the forwarding of packet data. For example, storage device 440 can store identities or addresses of network entities, such as any of network nodes 418, 420, 422, 424, and 426, eNBs 416 or UE 414. In the illustrative example, storage device 440 includes a first storage location 442 and a second storage location 444. First storage location 442 can be dedicated to storing a Currently Used Downlink address value 442. Likewise, second storage location 444 can be dedicated to storing a Default Downlink Forwarding address value 444. PGW 426 can read or write values into either of storage locations 442, 444, for example, managing Currently Used Downlink Forwarding address value 442 and Default Downlink Forwarding address value 444 as disclosed herein.

In some embodiments, the Default Downlink Forwarding address for each EPS bearer is the SGW S5-U address for each EPS Bearer. The Currently Used Downlink Forwarding address” for each EPS bearer in PGW 426 can be set every time when PGW 426 receives an uplink packet, e.g., a GTP-U uplink packet, with a new source address for a corresponding EPS bearer. When UE 414 is in an idle state, the “Current Used Downlink Forwarding address” field for each EPS bearer of UE 414 can be set to a “null” or other suitable value.

In some embodiments, the Default Downlink Forwarding address is only updated when PGW 426 receives a new SGW S5-U address in a predetermined message or messages. For example, the Default Downlink Forwarding address is only updated when PGW 426 receives one of a Create Session Request, Modify Bearer Request and Create Bearer Response messages from SGW 420.

As values 442, 444 can be maintained and otherwise manipulated on a per bearer basis, it is understood that the storage locations can take the form of tables, spreadsheets, lists, or other data structures generally well understood and suitable for maintaining or otherwise manipulate forwarding addresses on a per bearer basis.

It should be noted that access network 402 and core network 404 are illustrated in a simplified block diagram in FIG. 5. In other words, either or both of access network 402 and the core network 404 can include additional network elements that are not shown, such as various routers, switches, and controllers. In addition, although FIG. 5 illustrates only a single one of each of the various network elements, it should be noted that access network 402 and core network 404 can include any number of the various network elements. For example, core network 404 can include a pool (i.e., more than one) of MMEs 418, SGWs 420 or PGWs 426.

In the illustrative example, data traversing a network path between UE 414, eNB 416a, SGW 420, PGW 426 and external network 406 may be considered to constitute data transferred according to an end-to-end IP service. However, for the present disclosure, to properly perform establishment management in LTE-EPS network architecture 400, the core network, data bearer portion of the end-to-end IP service is analyzed.

An establishment may be defined herein as a connection set up request between any two elements within LTE-EPS network architecture 400. The connection set up request may be for user data or for signaling. A failed establishment may be defined as a connection set up request that was unsuccessful. A successful establishment may be defined as a connection set up request that was successful.

In one embodiment, a data bearer portion comprises a first portion (e.g., a data radio bearer 446) between UE 414 and eNB 416a, a second portion (e.g., an S1 data bearer 428) between eNB 416a and SGW 420, and a third portion (e.g., an S5/S8 bearer 432) between SGW 420 and PGW 426. Various signaling bearer portions are also illustrated in FIG. 5. For example, a first signaling portion (e.g., a signaling radio bearer 448) between UE 414 and eNB 416a, and a second signaling portion (e.g., S1 signaling bearer 430) between eNB 416a and MME 418.

In at least some embodiments, the data bearer can include tunneling, e.g., IP tunneling, by which data packets can be forwarded in an encapsulated manner, between tunnel endpoints. Tunnels, or tunnel connections can be identified in one or more nodes of network 400, e.g., by one or more of tunnel endpoint identifiers, an IP address, and a user datagram protocol port number. Within a particular tunnel connection, payloads, e.g., packet data, which may or may not include protocol related information, are forwarded between tunnel endpoints.

An example of first tunnel solution 450 includes a first tunnel 452a between two tunnel endpoints 454a and 456a, and a second tunnel 452b between two tunnel endpoints 454b and 456b. In the illustrative example, first tunnel 452a is established between eNB 416a and SGW 420. Accordingly, first tunnel 452a includes a first tunnel endpoint 454a corresponding to an S1-U address of eNB 416a (referred to herein as the eNB S1-U address), and second tunnel endpoint 456a corresponding to an S1-U address of SGW 420 (referred to herein as the SGW S1-U address). Likewise, second tunnel 452b includes first tunnel endpoint 454b corresponding to an S5-U address of SGW 420 (referred to herein as the SGW S5-U address), and second tunnel endpoint 456b corresponding to an S5-U address of PGW 426 (referred to herein as the PGW S5-U address).

In at least some embodiments, first tunnel solution 450 is referred to as a two-tunnel solution, e.g., according to the GPRS Tunneling Protocol User Plane (GTPv1-U based), as described in 3GPP specification TS 29.281, incorporated herein in its entirety. It is understood that one or more tunnels are permitted between each set of tunnel end points. For example, each subscriber can have one or more tunnels, e.g., one for each PDP context that they have active, as well as possibly having separate tunnels for specific connections with different quality of service requirements, and so on.

An example of second tunnel solution 458 includes a single or direct tunnel 460 between tunnel endpoints 462 and 464. In the illustrative example, direct tunnel 460 is established between eNB 416a and PGW 426, without subjecting packet transfers to processing related to SGW 420. Accordingly, direct tunnel 460 includes first tunnel endpoint 462 corresponding to the eNB S1-U address, and second tunnel endpoint 464 corresponding to the PGW S5-U address. Packet data received at either end can be encapsulated into a payload and directed to the corresponding address of the other end of the tunnel. Such direct tunneling avoids processing, e.g., by SGW 420 that would otherwise relay packets between the same two endpoints, e.g., according to a protocol, such as the GTP-U protocol.

In some scenarios, direct tunneling solution 458 can forward user plane data packets between eNB 416a and PGW 426, by way of SGW 420. For example, SGW 420 can serve a relay function, by relaying packets between two tunnel endpoints 416a, 426. In other scenarios, direct tunneling solution 458 can forward user data packets between eNB 416a and PGW 426, by way of the S1 U+ interface, thereby bypassing SGW 420.

Generally, UE 414 can have one or more bearers at any one time. The number and types of bearers can depend on applications, default requirements, and so on. It is understood that the techniques disclosed herein, including the configuration, management and use of various tunnel solutions 450, 458, can be applied to the bearers on an individual basis. For example, if user data packets of one bearer, say a bearer associated with a VoIP service of UE 414, then the forwarding of all packets of that bearer are handled in a similar manner. Continuing with this example, the same UE 414 can have another bearer associated with it through the same eNB 416a. This other bearer, for example, can be associated with a relatively low rate data session forwarding user data packets through core network 404 simultaneously with the first bearer. Likewise, the user data packets of the other bearer are also handled in a similar manner, without necessarily following a forwarding path or solution of the first bearer. Thus, one of the bearers may be forwarded through direct tunnel 458; whereas, another one of the bearers may be forwarded through a two-tunnel solution 450.

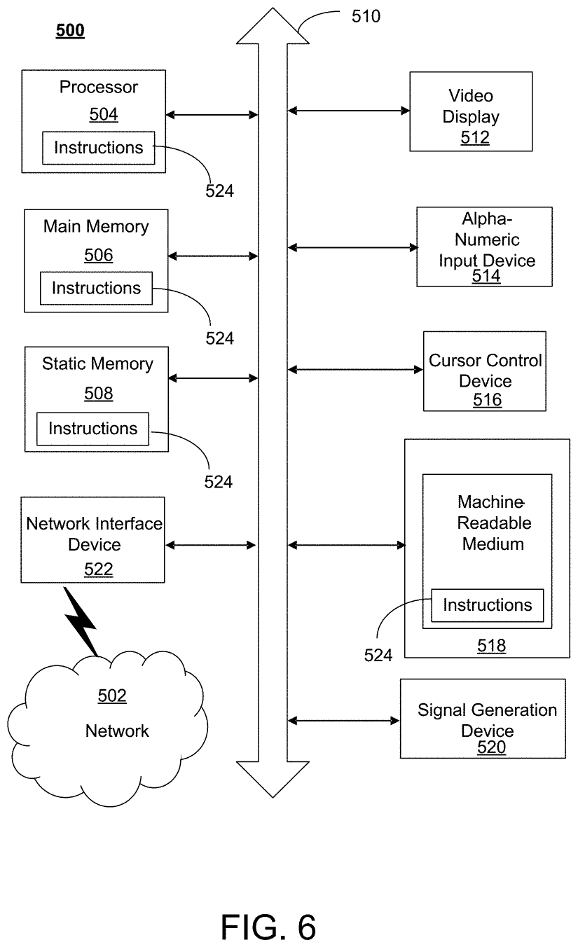

FIG. 6 depicts an exemplary diagrammatic representation of a machine in the form of a computer system 500 within which a set of instructions, when executed, may cause the machine to perform any one or more of the methods described above. One or more instances of the machine can operate, for example, as processor 302, UE 414, eNB 416, MME 418, SGW 420, HSS 422, PCRF 424, PGW 426 and other devices of FIGS. 1-4. In some embodiments, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video, or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid-state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the embodiments described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium 518 on which is stored one or more sets of instructions (e.g., software 524) embodying any one or more of the methods or functions described herein, including those methods illustrated above. Instructions 524 may also reside, completely or at least partially, within main memory 506, static memory 508, or within processor 504 during execution thereof by the computer system 500. Main memory 506 and processor 504 also may constitute tangible computer-readable storage media.

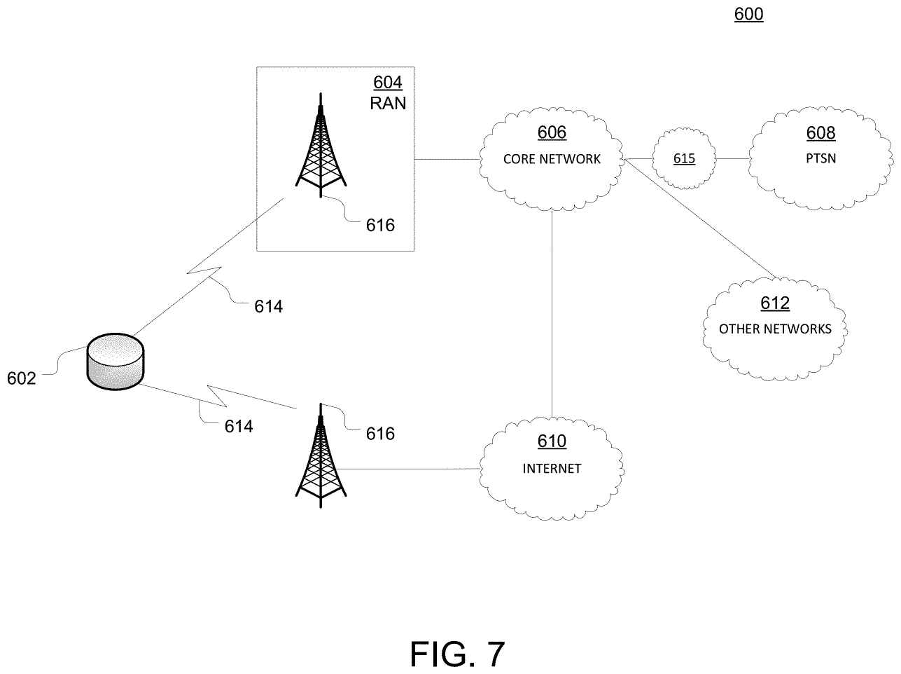

As shown in FIG. 7, telecommunication system 600 may include wireless transmit/receive units (WTRUs) 602, a RAN 604, a core network 606, a public switched telephone network (PSTN) 608, the Internet 610, or other networks 612, though it will be appreciated that the disclosed examples contemplate any number of WTRUs, base stations, networks, or network elements. Each WTRU 602 may be any type of device configured to operate or communicate in a wireless environment. For example, a WTRU may comprise IoT devices 32, mobile devices 33, network device 300, or the like, or any combination thereof. By way of example, WTRUs 602 may be configured to transmit or receive wireless signals and may include a UE, a mobile station, a mobile device, a fixed or mobile subscriber unit, a pager, a cellular telephone, a PDA, a smartphone, a laptop, a netbook, a personal computer, a wireless sensor, consumer electronics, or the like. WTRUs 602 may be configured to transmit or receive wireless signals over an air interface 614.

Telecommunication system 600 may also include one or more base stations 616. Each of base stations 616 may be any type of device configured to wirelessly interface with at least one of the WTRUs 602 to facilitate access to one or more communication networks, such as core network 606, PTSN 608, Internet 610, or other networks 612. By way of example, base stations 616 may be a base transceiver station (BTS), a Node-B, an eNodeB, a Home Node B, a Home eNodeB, a site controller, an access point (AP), a wireless router, or the like. While base stations 616 are each depicted as a single element, it will be appreciated that base stations 616 may include any number of interconnected base stations or network elements.

RAN 604 may include one or more base stations 616, along with other network elements (not shown), such as a base station controller (BSC), a radio network controller (RNC), or relay nodes. One or more base stations 616 may be configured to transmit or receive wireless signals within a particular geographic region, which may be referred to as a cell (not shown). The cell may further be divided into cell sectors. For example, the cell associated with base station 616 may be divided into three sectors such that base station 616 may include three transceivers: one for each sector of the cell. In another example, base station 616 may employ multiple-input multiple-output (MIMO) technology and, therefore, may utilize multiple transceivers for each sector of the cell.

Base stations 616 may communicate with one or more of WTRUs 602 over air interface 614, which may be any suitable wireless communication link (e.g., RF, microwave, infrared (IR), ultraviolet (UV), or visible light). Air interface 614 may be established using any suitable radio access technology (RAT).

More specifically, as noted above, telecommunication system 600 may be a multiple access system and may employ one or more channel access schemes, such as CDMA, TDMA, FDMA, OFDMA, SC-FDMA, or the like. For example, base station 616 in RAN 604 and WTRUs 602 connected to RAN 604 may implement a radio technology such as Universal Mobile Telecommunications System (UMTS) Terrestrial Radio Access (UTRA) that may establish air interface 614 using wideband CDMA (WCDMA). WCDMA may include communication protocols, such as High-Speed Packet Access (HSPA) or Evolved HSPA (HSPA+). HSPA may include High-Speed Downlink Packet Access (HSDPA) or High-Speed Uplink Packet Access (HSUPA).

As another example base station 616 and WTRUs 602 that are connected to RAN 604 may implement a radio technology such as Evolved UMTS Terrestrial Radio Access (E-UTRA), which may establish air interface 614 using LTE or LTE-Advanced (LTE-A).

Optionally base station 616 and WTRUs 602 connected to RAN 604 may implement radio technologies such as IEEE 602.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), GSM, Enhanced Data rates for GSM Evolution (EDGE), GSM EDGE (GERAN), or the like.

Base station 616 may be a wireless router, Home Node B, Home eNodeB, or access point, for example, and may utilize any suitable RAT for facilitating wireless connectivity in a localized area, such as a place of business, a home, a vehicle, a campus, or the like. For example, base station 616 and associated WTRUs 602 may implement a radio technology such as IEEE 602.11 to establish a wireless local area network (WLAN). As another example, base station 616 and associated WTRUs 602 may implement a radio technology such as IEEE 602.15 to establish a wireless personal area network (WPAN). In yet another example, base station 616 and associated WTRUs 602 may utilize a cellular-based RAT (e.g., WCDMA, CDMA2000, GSM, LTE, LTE-A, etc.) to establish a picocell or femtocell. As shown in FIG. 8, base station 616 may have a direct connection to Internet 610. Thus, base station 616 may not be required to access Internet 610 via core network 606.

RAN 604 may be in communication with core network 606, which may be any type of network configured to provide voice, data, applications, or voice over internet protocol (VoIP) services to one or more WTRUs 602. For example, core network 606 may provide call control, billing services, mobile location-based services, pre-paid calling, Internet connectivity, video distribution or high-level security functions, such as user authentication. Although not shown in FIG. 8, it will be appreciated that RAN 604 or core network 606 may be in direct or indirect communication with other RANs that employ the same RAT as RAN 604 or a different RAT. For example, in addition to being connected to RAN 604, which may be utilizing an E-UTRA radio technology, core network 606 may also be in communication with another RAN (not shown) employing a GSM radio technology.

Core network 606 may also serve as a gateway for WTRUs 602 to access PSTN 608, Internet 610, or other networks 612. PSTN 608 may include circuit-switched telephone networks that provide plain old telephone service (POTS). For LTE core networks, core network 606 may use IMS core 615 to provide access to PSTN 608. Internet 610 may include a global system of interconnected computer networks or devices that use common communication protocols, such as the transmission control protocol (TCP), user datagram protocol (UDP), or IP in the TCP/IP internet protocol suite. Other networks 612 may include wired or wireless communications networks owned or operated by other service providers. For example, other networks 612 may include another core network connected to one or more RANs, which may employ the same RAT as RAN 604 or a different RAT.

Some or all WTRUs 602 in telecommunication system 600 may include multi-mode capabilities. For example, WTRUs 602 may include multiple transceivers for communicating with different wireless networks over different wireless links. For example, one or more WTRUs 602 may be configured to communicate with base station 616, which may employ a cellular-based radio technology, and with base station 616, which may employ an IEEE 802 radio technology.

While examples of described telecommunications system have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an device for implementing telecommunications as described herein. When implemented on a general-purpose processor, the program code combines with the processor to provide a unique device that operates to invoke the functionality of a telecommunications system.

While a telecommunications system has been described in connection with the various examples of the various figures, it is to be understood that other similar implementations may be used, or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, a telecommunications system as described herein should not be limited to any single example, but rather should be construed in breadth and scope in accordance with the appended claims.

### Glossary

Autonomous System (AS) is a collection of connected Internet Protocol (IP) routing prefixes under the control of one or more network operators on behalf of a single administrative entity or domain that presents a common, clearly defined routing policy to the internet.

Border Gateway Protocol (BGP) is a path vector routing protocol for exchanging routing information among network elements in the same or different Autonomous System (AS). The function of a BGP-enabled network element (a BGP host or peer) is to exchange network reachability information with other BGP-enabled network elements. The most commonly implemented version of BGP is BGP-4.

Control Plane is the part of the router architecture that is concerned with drawing the network topology, or the information in a routing table that defines what to do with incoming packets. The control plane is responsible for populating the routing table, drawing network topology, forwarding table, which enable data plane functions (e.g., configuration, shuts down, etc.).

Data Path is a path in which network packets travel across network switches.

Data Plane refers to the functions and processes that forward packets/frames from one interface to another based on control plane logic. The routing table, forwarding table and the routing logic constitute the data plane function. Packets travel through the router and incoming and outgoing of frames are done based on control plane logic.

Edge computing is a general term for a cloud-based IT service environment located at the edge of a network. The purpose of edge computing and MEC is to bring real-time, high-bandwidth, low-latency access to latency-dependent applications, distributed at the edge of the network. Since edge computing is closer to the end user and apps, it allows for a new class of cloud-native applications and allows network operators to open their networks to a new ecosystem and value chain.

eNodeB is the hardware that is connected to the mobile phone network that communicates directly wirelessly with mobile handsets (UEs), like a base transceiver station (BTS) in GSM networks. The eNodeB is directly connected to the Core Network using the S1 interface. The eNodeB is a WLAN access point, i.e. it supports all Layer 1 and Layer 2 features associated to the E-UTRAN Orthogonal Frequency Division Multiplexing physical interface, and they are directly connected to network routers. The termination of Layer 2 protocols in eNodeB helps to decrease data-transmission latency.

E-UTRAN is the network architecture defined for the E-UTRA radio interface as a part of 3GPP LTE physical layer specification. E-UTRAN consists of eNBs, providing the E-UTRA user plane (PDCP/RLC/MAC/PHY) and control plane (RRC) protocol terminations towards the UE. The eNBs are interconnected with each other by means of the X2 interface. The eNBs are also connected by means of the S1 interface to the MME of the EPC by means of the S1-MME and to the Serving Gateway (S-GW) by means of the S1-U.

Evolved Packet Core (EPC) is a framework for giving data and converged voice on a network. EPC is based on a constant network connection or an always-on connection. The EPC helps in combining voice and data on an Internet Protocol service architecture.

Home Subscriber Server (HSS) is a centralized database of subscriber information. The role of the HSS is to communicate with the network and provide subscriber profile and authentication information.

Machine learning (ML) may involve algorithms that build a model based on training data in order to make predictions or decisions without being programmed to do so.

Machine type communication (MTC) relates to enabling direct communications among electronic devices, dubbed MTC devices, and/or enabling communications from MTC devices to a central MTC server or a set of MTC servers. Communications can use both wireless and fixed networks.

MEC Server provides computing resources, storage capacity, connectivity, and access to RAN information. It supports a multitenancy run-time and hosting environment for applications. The virtual appliance applications are delivered as packaged operating system virtual machine (VM) images.

Mobility Management Entity (MME) is in charge of all the Control plane functions related to subscriber and session management. From that perspective, the MME supports security procedures; terminal-to-network session handling; and idle terminal location management. The MME is linked through the S6 interface to the HSS which supports the database containing all the user subscription information.

Multiprotocol Label Switching (MPLS) is a routing technique in telecommunications networks that directs data from one node to the next based on short path labels rather than long network addresses, thus avoiding complex lookups in a routing table and speeding traffic flows

Multi-Access Edge Computing (MEC) is edge computing's standard architecture created by the European Telecommunications Standards Institute's (ETSI's) MEC group. An MEC application runs as a virtualized application, such as a virtual machine (VM) or a containerized application, on top of the virtualization infrastructure provided by the MEC host.

NFV Architecture includes major components including virtualized network functions (VNFs), NFV management and orchestration (MANO), and NFV Infrastructure (NFVI)—that work with traditional network components like OSS/BSS.

NFV Infrastructure (NFVI) is a key component of the NFV architecture that describes the hardware and software components on which virtual networks are built. NFVI is composed of NFV infrastructure points-of-presence (NFVI-PoPs) which are where the VNFs, including resources for computation, storage, and networking, are deployed by a network operator. NFVI networks interconnect the computing and storage resources contained in an NFVI-PoP. This may include specific switching and routing devices to allow external connectivity. NFVI works directly with VNFs and virtual infrastructure managers (VIMs) and in concert with the NFV orchestrator. NFV services are instantiated at the directive of the NFV orchestrator, which calls on VIMs that manage the resources from the underlying infrastructure (NVFI).

NFV management and network orchestration (MANO) is framework for the management and orchestration of all resources in a virtualized data center including compute, networking, storage, and virtual machine (VM) resources. The main focus of NFV MANO is to allow flexible on-boarding, sidestepping the chaos that can be associated with rapid spin-up of network components.

NFV orchestrator (NFVO) is a key component of the NFV MANO (network functions virtualization management and network orchestration) architectural framework, which helps standardize the functions of virtual networking to increase interoperability of software-defined networking (SDN) elements. The NFVO performs resource orchestration and network service orchestration, as well as other functions.

Packet Data Network Gateway (PDN-GW) is the termination point of the packet data interface towards the Packet Data Network. As an anchor point for sessions towards the external Packet Data Networks, the PDN GW also supports Policy Enforcement features (which apply operator-defined rules for resource allocation and usage) as well as packet filtering (like deep packet inspection for virus signature detection) and evolved charging support (like per URL charging).

PCRF (Policy and Charging Rules Function) Server manages the service policy and sends quality of service (QoS) setting information for each user session and accounting rule information.

Radio Access Point (RAP) is a wireless network device that acts as a portal for devices to connect to a local area network. Access points are used for extending the wireless coverage of an existing network and for increasing the number of users that can connect to it. A RAO is typically configured to serve wireless user devices over relatively small coverage areas and with generally less capacity as compared to a macro base station that is configured to serve a relatively large coverage area (“macro cell”) and consequently many more client devices.

Route Flow Control Platform (RFCP) may be used to implement routing applications by acting as an indirection layer for control protocol messages and RIB-(to-FIB)-to-OpenFlow transformations.

Route Reflector is a network routing component and is used to avoid the requirement of full meshing. The use of a route reflector relieves the requirement of actually fully meshing BGP peers, because the BGP RRS effectively acts as a centralization point of a number of clients to a server that chooses the best path between them and reflect the best path to other nodes. The BGP RRS also can compute a best path based on all paths that the RRS receives from internal BGP peers and reflect the best path back to clients. The use of route reflection can reduce the total number of required connections. The routing process may direct forwarding on the basis of routing tables, which maintain a record of the routes to various network destinations. Routing tables may be specified by an administrator, learned by observing network traffic or built with the assistance of routing protocols.

Router is a network device that connects devices within a network by forwarding data packets between them. This data can be sent between devices, or from devices to the internet. The router does this by assigning a local IP address to each of the devices on the network. A router is considered a layer-3 device because its primary forwarding decision is based on the information in the layer-3 IP packet, specifically the destination IP address. When a router receives a packet, it searches its routing table to find the best match between the destination IP address of the packet and one of the addresses in the routing table. Once a match is found, the packet is encapsulated in the layer-2 data link frame for the outgoing interface indicated in the table entry. A router typically only looks at the layer-3 addresses to make a forwarding decision. For pure IP forwarding, a router is designed to minimize the state information associated with individual packets. Once a packet is forwarded, the router does not retain any historical information about the packet.

S1 interface may be used between eNodeBs (in 4G) and the EPC: specifically, the MME and S-GW. The S1 interface includes the S1-CP (control) and S1-UP part (user plane). The protocols over S1 interfaces are divided into two groups: user-plane protocols that are the protocols implementing the actual E-UTRAN radio access bearer (E-RAB) service, i.e., carrying user data through the autonomous system, and control-plane protocols, which are responsible for controlling the E-RABs and the connection between the UE and the network from different aspects including requesting the service, controlling different transmission resources, and handover.

SDN Analytics Data may include actionable information about both legacy and SDN networks. SDN analytics deliver real-time visibility into both the control plane and data plane metrics such as the current state of the network, network topology, IGP and BGP routes, traffic utilization, latency, jitter, and device performance. Analytics data, which can be collected using an SDN Analytics application such as the Packet Design Explorer SDN Platform, provides network engineers with the management intelligence required to automate new service requests and model planned changes before actually provisioning it in the network via an SDN controller. For example, an SDN controller automatically provisioning a new transport path for a customer can use SDN analytics data to tell which path from a source to destination has the resources to meet the path constraints. And because SDN analytics provides visibility into the current state of the network, network changes can be planned and provisioned only if the change has no adverse impact on the network.

SDN Controller: intelligence that may configure network nodes (e.g. via OpenFlow protocol) and control application data traffic flow (e.g. compute optimal network paths) in the SDN network independent of network hardware. In general, SDNs involve the use of a standalone controller that performs the control functionality for a set of network devices. As an example of software defined networking, in the case of routing, rather than routers performing individual analyses to determine routes through the network, the controller can determine the routes and program other devices in the network to behave according to the determinations made by the controller. Different protocols may be used to implement software defined networking, including open protocols like OpenFlow, and proprietary protocols from network vendors.

SDN Orchestration is the process of automatically programming the behavior of the network, so that the network smoothly coordinates with the hardware and the software elements to further support applications and services. Orchestration platforms can include several types of Open source software, which are built using common APIs that could tie into standard networking technologies. SDN Orchestration involves coordinating software with an SDN Controller, which in turn is built using Open Source technology like OpenDaylight. The controller can also be programmed to make automatic decisions regarding the network in the case of network congestion, security problems, and faulty devices. Service Orchestration uses several network protocols including, OpenFlow and IP based networking.

Serving Gateway (S-GW) is the termination point of the packet data interface and serves as a local mobility anchor, meaning that packets are routed through this point for intra E-UTRAN mobility.

User Equipment (UE) may be any device used directly by an end-user to communicate. It can be a hand-held telephone, a laptop computer equipped with a mobile broadband adapter, or any other device. It connects to the base station Node B/eNodeB.

User plane function (UPF) supports packet routing & forwarding, packet inspection, QoS handling, acts as external PDU session point of interconnect to Data Network (DN), and is an anchor point for intra- & inter-RAT mobility. (UPF has part of the SGW & PGW functionality from EPC world). is related to the 3GPP 5G Architecture. It is similar to the roles played by the Serving/Packet Gateway in a 4G LTE system. The UPF supports features and capabilities to facilitate user plane operation. Examples include packet routing and forwarding, interconnection to the Data Network, policy enforcement and data buffering.

1. An apparatus, the apparatus comprising:
a processor; and
a memory coupled with the processor, the memory storing executable instructions that when executed by the processor, cause the processor to effectuate operations comprising:
receiving, by a software defined network (SDN) node, first telemetry data for components of a native autonomous system (AS) network, wherein the components of the native AS network comprise edge network devices and core network devices, wherein the SDN node comprises an artificial intelligence module;
analyzing, by the artificial intelligence module, the first telemetry data in order to predetermine network paths to route traffic during a network capacity shortage;
based on the analyzing of the first telemetry data, generating routing data of predetermined network paths to route traffic within the native AS and between the native AS and a neighboring AS during the network capacity shortage;
sending the routing data of predetermined network paths to route traffic within the native AS and between the native AS and the neighboring AS;
receiving, from the neighboring AS, neighboring data;
in response to receiving the neighboring data, analyzing, by the artificial intelligence module, the neighboring data; and
based on the analyzing of the neighboring data and the first telemetry data for components of the native AS network, updating the routing data.

2. The apparatus of claim 1, the operations further comprising distributing the routing data to the native AS or the neighboring AS using a Border Gateway Protocol (BGP).

3. The apparatus of claim 1, wherein the neighboring data comprises second telemetry data from the neighboring AS or a second routing data of predetermined network paths to route traffic between the neighboring AS and the native AS.

4. The apparatus of claim 1, wherein the analyzing, by the artificial intelligence module, the first telemetry data in order to predetermine network paths to route traffic during the network capacity shortage comprises: comparing the network capacity shortage to historical data associated with past network capacity shortages for the native AS network.

5. The apparatus of claim 1, wherein the analyzing, by the artificial intelligence module, the first telemetry data in order to predetermine network paths to route traffic during the network capacity shortage comprises determining alternate network paths comprising an alternate network technology, wherein the alternate network technology comprises power line communication or satellite communication.

6. The apparatus of claim 1, the operations further comprising receiving an indication of the network capacity shortage, wherein the network capacity shortage is indicative of a Distributed Denial of Service (DDOS) attack on a first link within the native AS.

7. The apparatus of claim 1, the operations further comprising receiving an indication of the network capacity shortage, wherein the network capacity shortage is indicative of a link down condition or Distributed Denial of Service (DDOS) attack on a first link within the neighboring AS.

8. The apparatus of claim 1, wherein the first telemetry data comprises capacity availability, call drops, routing links, network device failures, or end user device failures.

9. The apparatus of claim 1, wherein the first telemetry data comprises specific network metrics, time synchronization, local device traffic statistics, system status information, Syslog, Simple Network Management Protocol (SNMP), access control list (ACL) Logging, accounting, archive configuration change logger, packet capture, interface type, status, speed and duplex, encapsulation, errors on the interface, the last time a network device interface bounced, last time the network device or interface error counters reset, utilization of the network device components (e.g., CPU, interface bandwidth), IP addresses configured on a network device, subnet mask, and media access control (MAC) address configured on the network device, Global Positioning System (GPS) location of a network device, or facility location of a network device, among other things.

10. A computer-implemented method comprising:
receiving, by a software defined network (SDN) node, first telemetry data for components of a native autonomous system (AS) network, wherein the components of the native AS network comprise edge network devices and core network devices, wherein the SDN node comprises an artificial intelligence module;
analyzing, by the artificial intelligence module, the first telemetry data in order to predetermine network paths to route traffic during a network capacity shortage;
based on the analyzing of the first telemetry data, generating routing data of predetermined network paths to route traffic within the native AS and between the native AS and a neighboring AS during the network capacity shortage;
sending the routing data of predetermined network paths to route traffic within the native AS and between the native AS and the neighboring AS;
receiving, from the neighboring AS, neighboring data;
in response to receiving the neighboring data, analyzing, by the artificial intelligence module, the neighboring data; and
based on the analyzing of the neighboring data and the first telemetry data for components of the native AS network, updating the routing data.

11. The computer-implemented method of claim 10, further comprising further comprising distributing the routing data to the native AS or the neighboring AS using a Border Gateway Protocol (BGP).

12. The computer-implemented method of claim 10, wherein the neighboring data comprises second telemetry data from the neighboring AS or a second routing data of predetermined network paths to route traffic between the neighboring AS and the native AS.

13. The computer-implemented method of claim 10, wherein the analyzing, by the artificial intelligence module, the first telemetry data in order to predetermine network paths to route traffic during the network capacity shortage comprises: comparing the network capacity shortage to historical data associated with past network capacity shortages for the native AS network.

14. The computer-implemented method of claim 10, wherein the analyzing, by the artificial intelligence module, the first telemetry data in order to predetermine network paths to route traffic during the network capacity shortage comprises determining alternate network paths comprising an alternate network technology, wherein the alternate network technology comprises power line communication or satellite communication.

15. The computer-implemented method of claim 10 further comprising receiving an indication of the network capacity shortage, wherein the network capacity shortage is indicative of a Distributed Denial of Service (DDOS) attack on a first link within the native AS.

16. The computer-implemented method of claim 10 further comprising receiving an indication of the network capacity shortage, wherein the network capacity shortage is indicative of a link down condition or Distributed Denial of Service (DDOS) attack on a first link within the neighboring AS.

17. The computer-implemented method of claim 10, wherein the first telemetry data comprises capacity availability, call drops, routing links, network device failures, or end user device failures.

18. The computer-implemented method of claim 10, wherein the first telemetry data comprises specific network metrics, time synchronization, local device traffic statistics, system status information, Syslog, Simple Network Management Protocol (SNMP), access control list (ACL) Logging, accounting, archive configuration change logger, packet capture, interface type, status, speed and duplex, encapsulation, errors on the interface, the last time a network device interface bounced, last time the network device or interface error counters reset, utilization of the network device components (e.g., CPU, interface bandwidth), IP addresses configured on a network device, subnet mask, and media access control (MAC) address configured on the network device, Global Positioning System (GPS) location of a network device, or facility location of a network device, among other things.

19. A computer-readable storage medium storing executable instructions that when executed by a processor causes said processor to effectuate operations comprising:
receiving, by a software defined network (SDN) node, first telemetry data for components of a native autonomous system (AS) network, wherein the components of the native AS network comprise edge network devices and core network devices, wherein the SDN node comprises an artificial intelligence module;
analyzing, by the artificial intelligence module, the first telemetry data in order to predetermine network paths to route traffic during a network capacity shortage;
based on the analyzing of the first telemetry data, generating routing data of predetermined network paths to route traffic within the native AS and between the native AS and a neighboring AS during the network capacity shortage;
sending the routing data of predetermined network paths to route traffic within the native AS and between the native AS and the neighboring AS;
receiving, from the neighboring AS, neighboring data;
in response to receiving the neighboring data, analyzing, by the artificial intelligence module, the neighboring data; and
based on the analyzing of the neighboring data and the first telemetry data for components of the native AS network, updating the routing data.

20. The computer-readable storage medium of claim 19, further comprising receiving an indication of the network capacity shortage, wherein the network capacity shortage is indicative of a Distributed Denial of Service (DDOS) attack on a first link within the native AS or indicative of a link down condition or Distributed Denial of Service (DDOS) attack on a first link within the neighboring AS.
